(19) United States
(12) Patent Application Publication
(10) Pub. No.: US 2026/0110640 A1
(43) Pub. Date: Apr. 23, 2026

(54) OPTICAL ABERRATION COMPENSATION USING A DEFORMABLE MIRROR

(71) Applicant: Applied Materials Israel Ltd., Rehovot, IL (US)

(72) Inventors: Menachem Lapid, Rehovot (IL); Amir Shoham, Ness Ziona (IL)

(73) Assignee: Applied Materials Israel Ltd., Rehovot, IL (US)

(21) Appl. No.: 18/922,345

(22) Filed: Oct. 21, 2024

(51) Int. Cl. G01N 21/88; G01N 21/95; G02B 27/00

(52) U.S. Cl. CPC G01N 21/8806; G01N 21/9501; G02B 27/0025; G01N 2021/8848

(57) ABSTRACT

A method, a non-transitory computer readable medium and an inspection system having optical aberration compensation capabilities, the inspection system includes (a) an illumination unit, (b) a configuration unit that is configured to configure the illumination unit, and (c) a recipe unit. The configuring is executed according to a recipe that is associated with the region of the object; wherein the configuring of the illumination unit includes configuring the deformed mirror. The recipe unit is configured to obtain the recipe that is associated with the region. The inspection system is configured to inspect the region by illuminating the region of the object using the deformed mirror. The recipe is determined by an iterative process.

### BACKGROUND OF THE INVENTION

Defect detection includes illuminating an object such as a wafer with illuminated radiation and detecting radiation emitted from the object.

The quality of the defect detection process may be reduced due to object induced aberrations. For example—dense and three-dimensional (3D) memory arrays may introduce aberrations that are unpredictable.

There is a growing need to reduce the object induced aberrations—especially in cases where the aberrations are unpredictable.

There is a growing need to provide an efficient method for optical aberration compensation even when the aberrations are unpredictable.

### BRIEF SUMMARY OF THE INVENTION

There may be provided a method, a non-transitory computer readable medium and a system for optical aberration compensation using a deformable mirror.

According to an embodiment, there is provided an inspection system having optical aberration compensation capabilities, the inspection system includes (a) an illumination unit, (b) a configuration unit that is configured to configure the illumination unit and (c) a recipe unit. The configuring is executed according to a recipe that is associated with the region of the object. The configuring of the illumination unit includes configuring the deformed mirror. The recipe unit that is configured to obtain the recipe that is associated with the region. The inspection system is configured to inspect the region by illuminating the region of the object using the deformed mirror. The recipe is determined by an iterative process that includes performing multiple inspection iterations for inspecting a reference region to provide multiple inspection results. The multiple inspection iterations are executed using multiple setups that differ from each other. A first group of setups of the multiple setups differ from each other by at least a configuration of a reference deformable mirror of the reference illumination unit. The iterative process includes (i) determining aberration dependent quality values of the multiple inspection iterations and (ii) selecting, out of the multiple setups, a setup to be applied when inspecting an inspected region that is relevant to the reference region, wherein the selecting is based on the aberration dependent quality values.

According to an embodiment there is provided a method for optical aberration compensation using a deformable mirror of an illumination unit. The method includes (a) determining to inspect a region of an object, (b) configuring the illumination unit, and (c) inspecting the region. The configuring is executed according to a recipe that is associated with the region of the object. The configuring of the illumination unit includes configuring the deformed mirror. The inspecting of the region includes illuminating the region of the object using the deformed mirror. The recipe is determined by an iterative process that includes performing multiple inspection iterations for inspecting a reference region to provide multiple inspection results. The multiple inspection iterations are executed using multiple setups that differ from each other. A first group of setups of the multiple setups differ from each other by at least a configuration of a reference deformable mirror of the reference optics. The iterative process includes (i) determining aberration dependent quality values of the multiple inspection iterations, and (ii) selecting, out of the multiple setups, a setup to be applied when inspecting an inspected region that is relevant to the reference region. The selecting is based on the aberration dependent quality values.

According to an embodiment there is provided a non-transitory computer readable medium for optical aberration compensation using a deformable mirror of an illumination unit, the non-transitory computer readable medium that stores instructions for: determining to inspect a region of an object, (b) configuring the illumination unit, and (c) inspecting the region. The configuring is executed according to a recipe that is associated with the region of the object. The configuring of the illumination unit includes configuring the deformed mirror. The inspecting of the region includes illuminating the region of the object using the deformed mirror. The recipe is determined by an iterative process that includes performing multiple inspection iterations for inspecting a reference region to provide multiple inspection results. The multiple inspection iterations are executed using multiple setups that differ from each other. A first group of setups of the multiple setups differ from each other by at least a configuration of a reference deformable mirror of the reference optics. The iterative process includes (i) determining aberration dependent quality values of the multiple inspection iterations, and (ii) selecting, out of the multiple setups, a setup to be applied when inspecting an inspected region that is relevant to the reference region. The selecting is based on the aberration dependent quality values.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of a substrate;

FIG. 4 illustrates an example of a system;

FIG. 5 illustrates an example of a system; and

FIG. 6 illustrates examples of deformable mirrors.

### DETAILED DESCRIPTION OF THE INVENTION

There is provided an inspection system, a method, and a non-transitory computer readable medium that stores instructions for optical aberration compensation.

For simplicity of explanation the specification refers to the method. The method includes determining a recipe and utilizing the recipe for inspection. The recipe may be updated over time.

A recipe may be applicable per regions that are similar to each other.

The similarity may require that the regions be ideally identical - thus at an absence of defects the regions should be identical.

On the other hand—the similarity may allow predefined difference between the regions even at the absence of defects.

The similarity may require that the inspection (obtained by applying the recipe) process will provide accurate enough results.

What amounts to “accurate enough” may be determined in any manner. For example, the accuracy may be measured as a function of at least one of false positives, false negatives, true positives or false positives.

A region may be of any size and may include any content. Non-limiting examples of a region may include a 3D memory unit, 3D logic, a part of a 3D memory unit, at least a part of an immersion inspected object, at least a part of an object that has a fully or partially transparent upper layer, and the like.

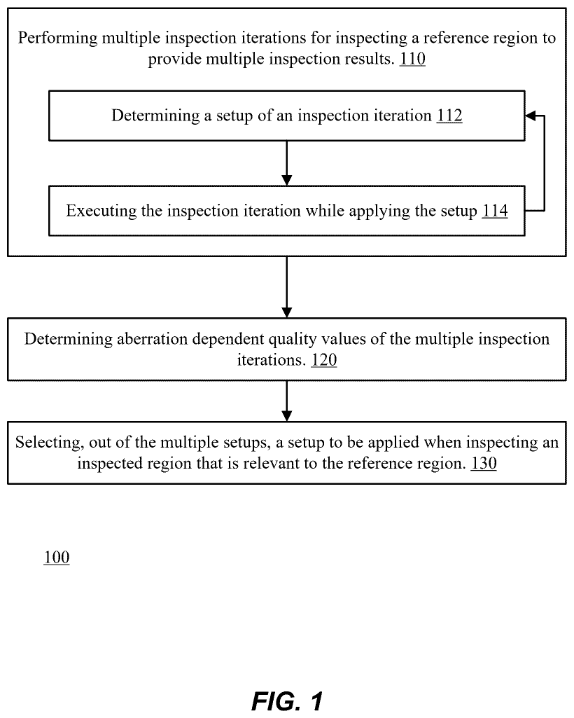

FIG. 1 illustrates method 100 for generating a recipe.

According to an embodiment, method 100 starts with step 110 of performing multiple inspection iterations for inspecting a reference region to provide multiple inspection results.

The term reference means that the region is used to build a recipe.

According to an embodiment, step 110 includes steps 112 and 114.

According to an embodiment, step 112 includes determining a setup of an inspection iteration.

According to an embodiment, step 112 is followed by step 114 of executing the inspection iteration while applying the setup. The output of the execution is an inspection iteration result.

According to an embodiment, step 114 includes setting the setup and then performing an inspection iteration to provide an inspection iteration result.

According to an embodiment, step 114 is followed by checking if there is a need to perform another inspection iteration—and is there is a need then jumping to step 112 in which a new setup is determined.

In step 110 the multiple inspection iterations are executed using multiple setups that differ from each other.

The differences between one setup to another may include differences in one or more out of (a) configuration of a reference deformable mirror of the reference optics, (b) a polarization parameter of light emitted on the reference region, (c) an angular difference related to at least one out of illumination or collection, or (d) least a type of defect that is being evaluated.

There may be other differences—for example more than four differences—and any reference to differences (a)-(b) should be applied mutatis mutandis to any other differences or to any other number of possible differences.

Accordingly—one setup may differ from another by one or more of (a), (b), (c) or (d).

Setups of a first group of setups (of the multiple setups) may differ from each other by a configuration of a reference deformable mirror of the reference optics.

Setups of a second group of setups (of the multiple setups) may differ from each other by a polarization parameter of light emitted on the reference region.

Setups of a third group of setups (of the multiple setups) may differ from each other by an angular difference related to at least one out of illumination or collection.

Setups of a fourth group of setups (of the multiple setups) may differ from each other by a type of defect that is being evaluated.

Setups of a fourth group of setups (of the multiple setups) may differ from each other by a type of pattern inspected (3D or 2D).

According to an embodiment the setups are selected to decrease the effect of pattern (3D or 2D) on the signal to noise ratio if there will be any defect—to provide a method of de-masking to provide an era of interest where there might be important defect(s) to capture.

A setup (of the multiple setups) may belong to any one of the first till fourth groups—or may belong to any combination of two till four groups of the first till fourth groups.

According to an embodiment, step 110 is followed by step 120 of determining aberration dependent quality values of the multiple inspection iterations. This may include determining an aberration dependent quality value per inspection iteration.

It should be noted that according to an embodiment, step 110 and step 120 are executed in at least a partially overlapping manner—for example in a pipelined manner.

For example—a determining of an aberration dependent quality value of an inspection iteration may be executed in parallel to an execution of another inspection iteration.

An aberration dependent quality value may be a signal to noise ratio value. The signal to noise value may be calculated based on a knowledge of the expected defects of the region and/or the expected structure of the region.

An aberration dependent quality value may reflect a relationship between an expected inspection iteration result and an actual inspection iteration result.

For example—the aberration dependent quality value may reflect a relationship between an expected number of defects to be found during an inspection iteration and an actual number of defects found during the inspection iteration. For example—if there much more defects that expected then the inspection iteration may be suspected as providing false positives.

According to an embodiment, step 120 is followed by step 130 of selecting, out of the multiple setups, a setup to be applied when inspecting an inspected region that is relevant to the reference region. The selecting is based on the aberration dependent quality values. For example—selecting an aberration dependent quality value that is indicative of highest valued inspection iteration of the multiple inspection iterations.

According to an embodiment the methos includes configuring the deformable mirror initially according to computer simulations of the physics that suggest specific set up as initial guidance for the process.

According to an embodiment the methos includes configuring the deformable mirror to increase a defected signal or to decrease background noise—each separately or together to increase the signal to noise ratio.

It should be noted that step 130 may be executed in a gradual manner. Instead of waiting for all of the multiple inspection iterations to end—step 130 is applied per some of the multiple inspection iterations, and then be used for some other of the inspection iterations.

For example—step 110 includes executing a certain group of inspection iterations, step 120 is executed to determine aberration dependent quality values of the certain group of inspection iterations, and step 130 is applied to select a selected setup for the certain group of inspection iterations.

According to an embodiment, step 130 is used to determine a parameter related to the group. A related parameter to the first group may be a configuration of a reference deformable mirror. A related parameter to the second group may be a polarization parameter of light emitted on the reference region. A related parameter to the third group may be an angular difference related to at least one out of illumination or collection. A related parameter to the fourth group may be a type of defect that is being evaluated.

According to an embodiment, step 130 is used to determine a combination of parameters related to two or more groups.

According to an embodiment, steps 110, 120 and 130 are executed in a partially overlapping manner—for example in a pipelined manner.

Assuming that there are N different parameters than all or only some of the combinations or sub-combinations of the N parameters may be evaluated during method 100.

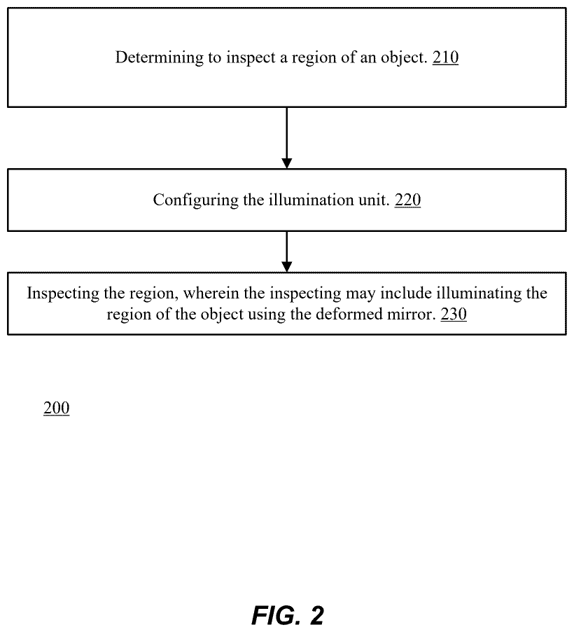

FIG. 2 illustrates an example of method 200 of optical aberration compensation using a deformable mirror of an illumination unit.

According to an embodiment, method 200 starts with step 210 of determining to inspect a region of an object.

According to an embodiment, step 210 may be followed by step 220 of configuring the illumination unit.

The configuring is executed according to a recipe that is associated with the region of the object.

According to an embodiment, the recipe is a recipe determined using method 100, whereas the reference region is related to the region to be inspected.

The configuring of the illumination unit includes configuring the deformed mirror. The configuring may include configuring at least one other unit or elements.

According to an embodiment, step 220 is followed by step 230 of inspecting the region, wherein the inspecting includes illuminating the region of the object using the deformed mirror.

According to an embodiment, method 100 and method 200 are executed on the same object. Alternatively—the region and the reference region may belong to different objects.

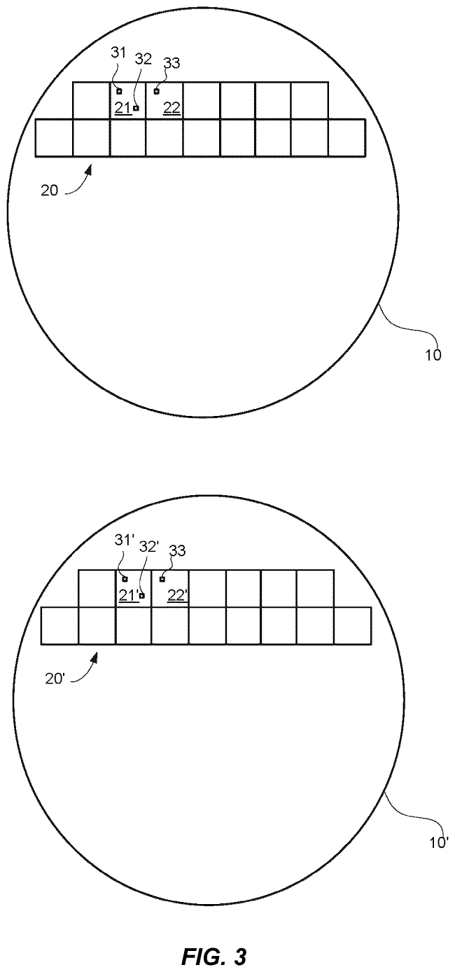

FIG. 3 is an example of a wafer 10 and other wafer 10′.

Wafer 10 is illustrated as including dies that are collectively denoted 20. The dies include a first die 21 and a second die 22. The first die includes a first region 31 and a second region 32. The second die includes a third region 33.

According to an embodiment, the first region 31 is similar to the second region 32 and the third region 33. For example—the first region 31 is ideally identical to the second region 32 and the third region 33. Ideally identical—at the absence of defects the first region is identical to the second region and to the third region.

According to an embodiment, method 100 is applied on the first region 31 to generate a recipe. The recipe may be applied (during method 200) when inspecting the second region 32 and the third region 33.

Alternatively—the recipe is applied (during method 200) only on the third region 33 as the third region and the first region belong to different dies. In this case the recipe may be generated based on the inspection of the first region only or be generated based on results of inspection iterations applied of the first region 31 and in results of inspection iterations applied on the second region 32.

Yet according to another example—the recipe is applied only on regions that belong to wafer that differ from wafer 10—for example is applied other wafer 10′.

Other wafer 10′ is illustrated as including other dies that are collectively denoted 20′. The other dies include a first other die 21′ and a second other die 22′. The first other die includes a first other region 31′ and a second other region 32′. The second other die includes a third other region 33.

According to an embodiment, the first other region 31′ is similar to the first region 31, to the second other region 32′ and the third other region 33′. For example—the first other region 31′ is ideally identical to first region 31, the second other region 32′ and the third other region 33′.

According to an embodiment, and as indicated above-method 100 is applied on the first region 31 to generate a recipe. According to an embodiment, the recipe is applied (during method 200) when inspecting the first other second region 31′, the second other region 32′, and the third other region 33′.

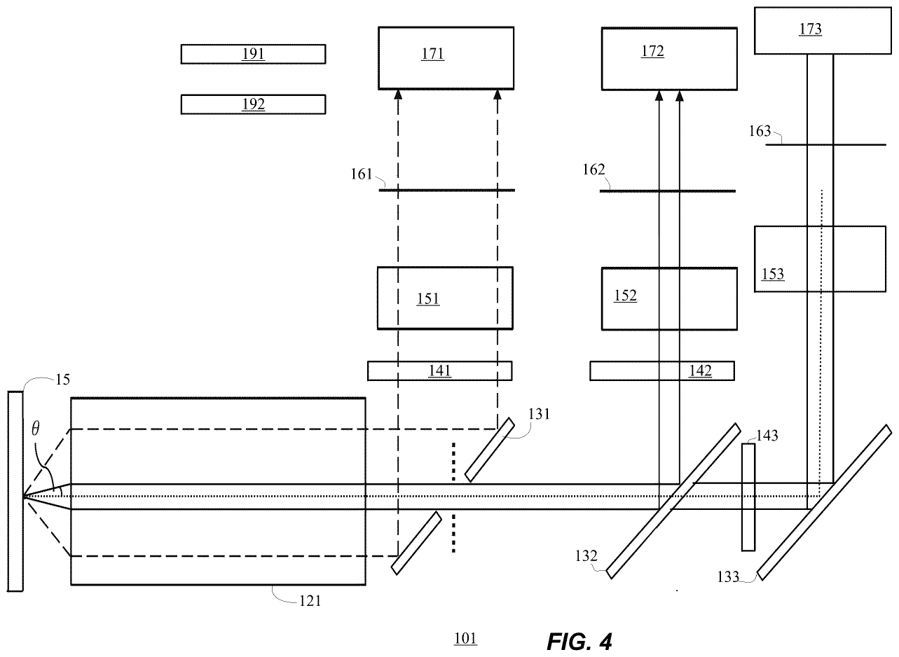

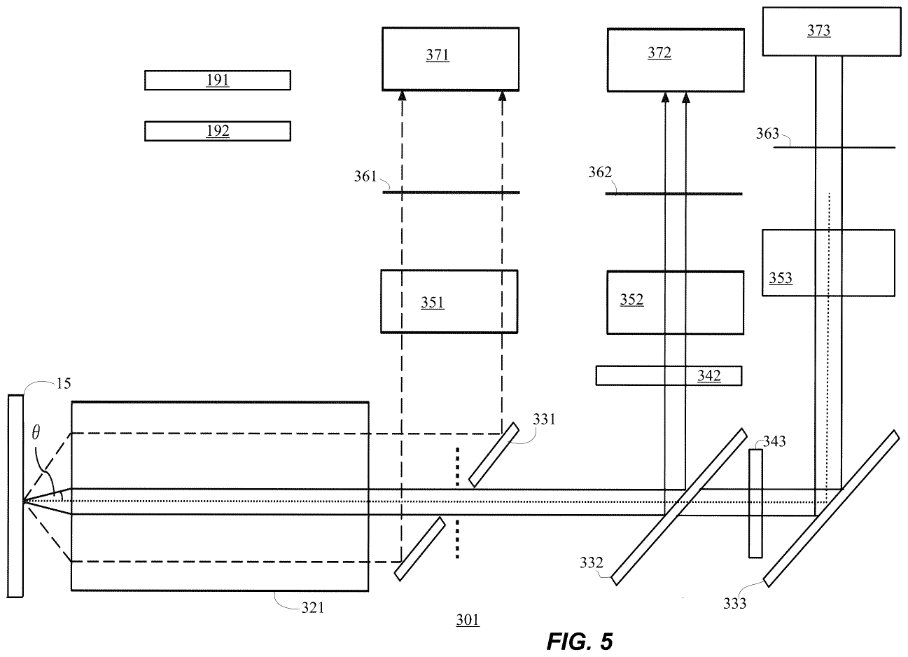

FIG. 4 and FIG. 5 illustrate example of inspection systems.

FIG. 4 illustrates inspection system 101 and object 15. The inspection system includes a collection branch, a bright field illumination branch, a dark field illumination branch, an objective lens 121 and additional optical elements.

The collection branch includes a collection module 173 that includes a sensor and has a collection module exit pupil 163, and collection branch pupil relay module 153.

The collection branch pupil relay module is preceded by deformable mirror 133 and by a collection branch polarization element 143 such as a half wave plate or quarter wave plate.

The bright field illumination branch includes a bright field illumination module 172 that has a bright field module exit pupil 162, bright field pupil relay module 152, and a bright field polarization element 142 such as a half wave plate or quarter wave plate.

The bright field polarization element 142 is preceded by a bright field mirror 132 that has an aperture through which illumination directed towards the collection branch passes.

The dark field illumination branch includes a dark field illumination module 171 that has a dark field module exit pupil 161, dark field pupil relay module 151, and a dark field polarization element 141 such as a half wave plate or quarter wave plate.

The dark field polarization element 141 is preceded by a dark field beam splitter 131 that has an aperture through which illumination directed towards the collection branch passes and through which bright field illumination passes.

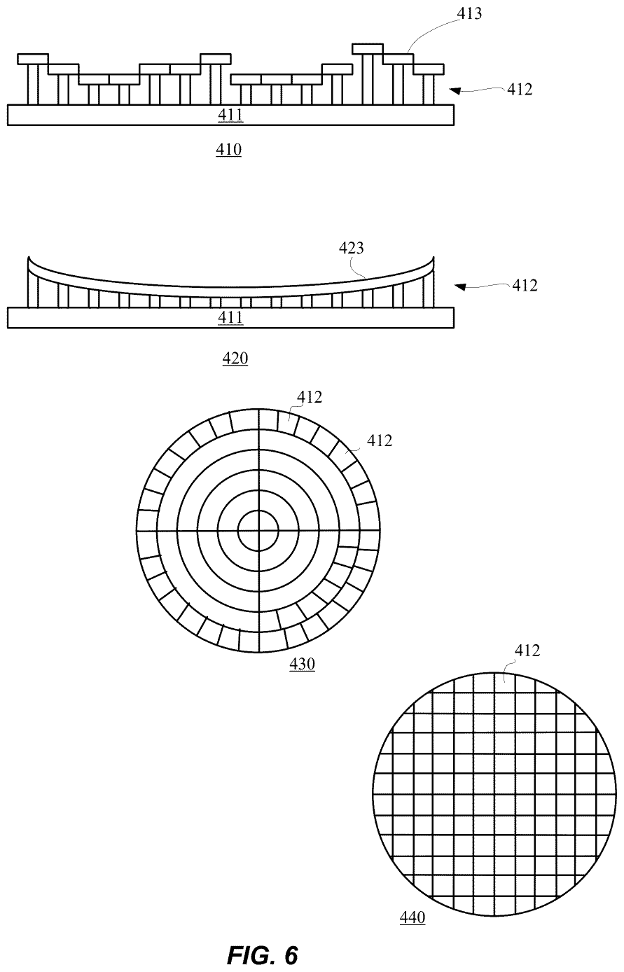

The deformable mirror has at least one region that is movable in relation to the collection branch. See examples of deformable mirrors in FIG. 6.

FIG. 4 also illustrates the inspection system to include (a) configuration unit 191 that is configured to configure the illumination unit; wherein the configuring is executed according to a recipe that is associated with the region of the object, wherein the configuring of the illumination unit comprises configuring the deformed mirror, and (b) a recipe unit 192 that is configured to obtain the recipe that is associated with the region.

FIG. 5 illustrates inspection system 301 and object 15. The inspection system includes an illumination branch, a bright field collection branch, a dark field collection branch, an objective lens 321, and additional optical elements.

The illumination branch includes an illumination module 373 that has an illumination module exit pupil 363, and an illumination branch pupil relay module 353.

The illumination branch pupil relay module is followed by a deformable mirror 333 and by an illumination branch polarization element 343 such as a half wave plate or quarter wave plate.

The bright field collection branch includes a bright field collection module 372 that includes a bright field sensor and has a bright field module exit pupil 362, a bright field pupil relay module 352, and a bright field polarization element 342 such as a half wave plate or quarter wave plate.

The bright field polarization element 342 is preceded by a bright field mirror 332 that has an aperture through which radiation directed towards the illumination branch passes.

The dark field collection branch includes a dark field collection module 371 that includes a dark field sensor and has a dark field module exit pupil 361, and a dark field pupil relay module 351.

The dark field pupil relay module 351 is preceded by a dark field beam splitter 331 that has an aperture through which radiation directed towards the bright field collection branch passes and through which illumination radiation passes.

The deformable mirror 333 has at least a region that is movable in relation to the illumination branch.

FIG. 5 also illustrates the inspection system to include (a) configuration unit 191 that is configured to configure the illumination unit; wherein the configuring is executed according to a recipe that is associated with the region of the object, wherein the configuring of the illumination unit includes configuring the deformed mirror, and (b) a recipe unit 192 that is configured to obtain the recipe that is associated with the region.

FIG. 6 illustrates examples of deformable mirrors.

Example 410 illustrates a cross section of a segmented deformable mirror that includes mirrors segments 413 that are movable by actuators 412 independently from each other. The actuators are positioned on base 411.

Example 420 illustrates a cross section of a continuous deformable mirror that includes a continuous surface mirror 423 that is deformed by actuators 412. The actuators are positioned on base 411.

The actuators and/or the segments may be arranged in any manner. Example 430 is a top view of the actuators 412 that are radially arranged (for simplicity of explanation only some of the actuators are shown).

Example 440 is a top view of the actuators 412 that are arranged in a rectangular grid (for simplicity of explanation only some of the actuators are shown).

Examples of manufacturers of deformable mirrors include Thorlabs Inc. of Newton, New Jersey, USA, LAS Photonics Ltd. of Ra'anana, Israel, and Boston Micromachines Corporation Inc. of Cambridge, Massachusetts, USA.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure

Any reference in the specification to a method should be applied mutatis mutandis to a system capable of executing the method and/or should be applied mutatis mutandis to a non-transitory computer readable medium that stores instruction for implementing the method.

Any reference in the specification to a system should be applied mutatis mutandis to a method that may be executed by the system and/or should be applied mutatis mutandis to a non-transitory computer readable medium that stores instruction executable by the system.

Any reference in the specification to a non-transitory computer readable medium that stores instruction should be applied mutatis mutandis to a method for executing the instructions and/or should be applied mutatis mutandis to a system capable of executing the instructions.

The term “and/or”means additionally or alternatively.

In the foregoing specification, the embodiments of the disclosure have been described with reference to specific examples of embodiments of the disclosure. It will, however, be evident that various modifications and changes may be made therein without departing from the broader spirit and scope of the embodiments of the disclosure as set forth in the appended claims.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,”or “operably coupled,”to each other to achieve the desired functionality.

Furthermore, those skilled in the art will recognize that boundaries between the above-described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments of the disclosure s containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiments of the disclosure.

Any combination of any module or unit listed in any of the figures, any part of the specification and/or any claims may be provided. Any combination of any claimed feature may be provided.

Any reference to the term “comprising” or “having” should be applied mutatis mutandis to each one out of “consisting” of “essentially consisting of”. For example—a method that comprises certain steps can include additional steps, can be limited to the certain steps, or may include additional steps that do not materially affect the basic and novel characteristics of the method—respectively.

The foregoing specification includes specific examples of one or more embodiments. It will, however, be evident that various modifications and changes may be made therein without departing from the broader spirit and scope of the one or more embodiments as set forth in the appended claims.

What is claimed is:

1. A method for optical aberration compensation using a deformable mirror of an illumination unit, the method comprising:
determining to inspect a region of an object;
configuring the illumination unit; wherein the configuring is executed according to a recipe that is associated with the region of the object; wherein the configuring of the illumination unit comprises configuring the deformed mirror; and
inspecting the region, wherein the inspecting comprises illuminating the region of the object using the deformed mirror;
wherein the recipe is determined by an iterative process that comprises:
performing multiple inspection iterations for inspecting a reference region to provide multiple inspection results; wherein the multiple inspection iterations are executed using multiple setups that differ from each other; wherein a first group of setups of the multiple setups differ from each other by at least a configuration of a reference deformable mirror of the reference optics;
determining aberration dependent quality values of the multiple inspection iterations; and
selecting, out of the multiple setups, a setup to be applied when inspecting an inspected region that is relevant to the reference region, wherein the selecting is based on the aberration dependent quality values.

2. The method according to claim 1, wherein a second group of setups of the multiple setups differ from each other by at least a polarization parameter of light emitted on the region.

3. The method according to claim 1, wherein a second group of setups of the multiple setups differ from each other by at least an angle of incidence polarization parameter.

4. The method according to claim 1, wherein the aberration dependent quality values are signal to noise ratio values.

5. The method according to claim 1, wherein an aberration dependent quality value reflects a relationship between an expected inspection iteration result and an actual inspection iteration result.

6. The method according to claim 1, wherein an aberration dependent quality value reflect a relationship between an expected number of defects to be found during an inspection iteration and an actual number of defects found during the inspection iteration.

7. The method according to claim 1, wherein a third group of setups of the multiple setups differ from each other by at least a type of defect that is being evaluated.

8. The method according to claim 1, wherein the region is ideally identical to the reference region.

9. The method according to claim 1, wherein the region and the reference region belong to a same object.

10. The method according to claim 1, wherein the region and the reference region belong to different objects.

11. The method according to claim 1, wherein the region comprises at least a portion of a three dimensional structural element that has a high aspect ratio, wherein a high aspect ratio exceeds ten.

12. The method according to claim 1, wherein the region comprises at least a portion of a three dimensional structural element that comprises one or more cavities having a depth that exceeds three microns.

13. The method according to claim 1, wherein the inspection of the region comprises is an immersion based inspection.

14. The method according to claim 1, wherein the inspection of the region comprises searching for buried defects located within a depth range that exceeds two microns.

15. A non-transitory computer readable medium for optical aberration compensation using a deformable mirror of an illumination unit, the non-transitory computer readable medium stores instructions for:
determining to inspect a region of an object;
configuring the illumination unit; wherein the configuring is executed according to a recipe that is associated with the region of the object; wherein the configuring of the illumination unit comprises configuring the deformed mirror; and
inspecting the region, wherein the inspecting comprises illuminating the region of the object using the deformed mirror;
wherein the recipe is determined by an iterative process that comprises:
performing multiple inspection iterations for inspecting a reference region to provide multiple inspection results; wherein the multiple inspection iterations are executed using multiple setups that differ from each other; wherein a first group of setups of the multiple setups differ from each other by at least a configuration of a reference deformable mirror of the reference illumination unit;
determining aberration dependent quality values of the multiple inspection iterations; and
selecting, out of the multiple setups, a setup to be applied when inspecting an inspected region that is relevant to the reference region, wherein the selecting is based on the aberration dependent quality values.

16. An inspection system having optical aberration compensation capabilities, the inspection system comprising:
an illumination unit;
a configuration unit that is configured to configure the illumination unit; wherein the configuring is executed according to a recipe that is associated with a region of an object;
wherein the configuring of the illumination unit comprises configuring a deformed mirror; and
a recipe unit that is configured to obtain the recipe that is associated with the region; and
wherein the inspection system is configured to inspect the region by illuminating the region of the object using the deformed mirror;
wherein the recipe is determined by an iterative process that comprises:
performing multiple inspection iterations for inspecting a reference region to provide multiple inspection results; wherein the multiple inspection iterations are executed using multiple setups that differ from each other; wherein a first group of setups of the multiple setups differ from each other by at least a configuration of a reference deformable mirror of the reference illumination unit;
determining aberration dependent quality values of the multiple inspection iterations; and
selecting, out of the multiple setups, a setup to be applied when inspecting an inspected region that is relevant to the reference region, wherein the selecting is based on the aberration dependent quality values.
